(19) United States
(12) Patent Application Publication
(10) Pub. No.: US 2004/0161135 A1
(43) Pub. Date: Aug. 19, 2004

(54) Fingerprint matching device, fingerprint matching method, and program

(76) Inventors: Misa Sano, Kanagawa (JP); Masato Nishizawa, Kanagawa (JP); Chihiro Ueki, Kanagawa (JP); Tomoyuki Tsurube, Tokyo (JP); Yoshiyuki Matsuyama, Kanagawa (JP); Ryosuke Iida, Kanagawa (JP); Chie Ide, Kanagawa (JP); Sachiko Shiina, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/478,409

(22) PCT Filed: Mar. 11, 2003
(86) PCT No.: PCT/JP03/02838

(30) Foreign Application Priority Data
Mar. 12, 2002 (JP) 2002-067011

(51) Int. Cl. G06K 9/00

(52) U.S. Cl. 382/124

(57) ABSTRACT

A fingerprint ID device includes input means for receiving a fingerprint image, center detecting means for detecting a center point of a fingerprint from the fingerprint image, area extracting means for extracting a given area, which surrounds the center point, as a center image of the fingerprint, and checking means for checking the center image against fingerprint images registered in advance. This structure allows checking a fingerprint by using the center image which includes a large number of characteristics. Thus even if the finger deviates from a right position, the fingerprint can be identified with accuracy, and at the same time, a memory capacity of the device can be substantially reduced.

### TECHNICAL FIELD

The present invention relates to a fingerprint ID device, a method of identifying fingerprints, and a program-executing the same method.

### BACKGROUND ART

A method of identifying individuals with fingerprints can increase its accuracy by collecting more characteristics of a fingerprint. One of the measures to collect more characteristics is disclosed in Japanese Patent Application S61-59583, and this is called “method of determining a picture center”. FIG. 18 shows a structure of a conventional fingerprint ID device using the method of determining a picture center. The device shown in FIG. 18 comprises the following elements:

input section 1801 for receiving a fingerprint image;

keyboard 1802 for inputting ID numbers;

controller 1803;

image memory 1804 for storing the fingerprint image received by the input section;

check section 1805 for checking the characteristics of the received fingerprint against characteristics data stored;

file 1806 for storing the characteristics data in advance;

direction detector 1807 for detecting a direction of the picture of the received fingerprint; and

centerline determiner 1808 for determining a picture center based on the direction detected by detector 1807.

A fingerprint image supplied to the fingerprint ID device is scanned by input section 1801 and digitized for being stored in image memory 1804. An input of an ID number through keyboard 1802 prompts to access file 1806 which has stored characteristics information of plural fingerprints, and the characteristics information designated by the ID number is read and sent to check section 1805. On the other hand, direction detector 1807 detects a picture center of the fingerprint-image stored in memory 1804, and centerline determiner 1808 determines a vertical centerline of the fingerprint picture based on the direction detected. Controller 1803 extracts fingerprint characteristics from the fingerprint image stored in image memory 1804 based on the centerline determined. Check section 1805 compares the fingerprint characteristics extracted from the fingerprint image in memory 1804 with the characteristics information stored in file 1806, so that the fingerprint is identified.

Find line-directions and distributions of the line-directions of a fingerprint image, thereby finding a centerline of the fingerprint vertical-wise. When a fingerprint to be scanned is input into the input section, match a scanning center to the vertical centerline of the fingerprint, so that the fingerprint supplied can be scanned overall. As a result, an amount of characteristics collected from the fingerprint image increases, thereby improving identification accuracy.

However, the foregoing conventional method of identifying a fingerprint cannot obtain a correct fingerprint image. In other words, the conventional method detects a center direction of a fingerprint only vertical-wise, so that when a fingerprint is deviated horizontally at inputting due to a positional shift of the finger, no horizontal correction is made. Therefore, a fingerprint image cannot be obtained correctly. In the case of extracting characteristics by using frequency-analysis for the identification algorithm, in particular, an amount of characteristics is varied by horizontal deviation, so that the identification accuracy is lowered. Further, the conventional method requires all the image data because it detects a vertical centerline to be matched to a scanning center, so that a bulk image memory must be prepared.

### DISCLOSURE OF THE INVENTION

The present invention addresses the problems discussed above, and aims to check the data of a fingerprint by using an area which includes a large amount of characteristics, and even if a finger deviates from a right position, the fingerprint can be identified accurately. The present invention also aims to reduce substantially a memory capacity.

In order to overcome the problems discussed above, a fingerprint ID device of the present invention comprises the following elements:

input means for receiving a fingerprint image;

center detecting means for detecting a fingerprint center from the fingerprint image;

area extracting means for extracting a center image of the fingerprint in a given area of which center is a fingerprint center; and

checking means for checking the center image of the fingerprint against fingerprint-images registered in advance.

This structure allows checking a fingerprint against data by using an area that includes a large amount of characteristics, and achieves an accurate identification of a fingerprint even if the finger deviates from a right position. This structure can also reduce a large capacity of memory.

### BRIEF DESCRIPTION OF THE DRAWINGS

FIG. 1 is a block diagram showing functions of a fingerprint ID device in accordance with a first exemplary embodiment of the present invention.

FIG. 2 is a block diagram showing functions of a center-detector of the fingerprint ID device in accordance with the first exemplary embodiment of the present invention.

FIG. 3 is a block diagram showing functions of an area extractor of the fingerprint ID device in accordance with the first exemplary embodiment of the present invention.

FIG. 4 illustrates an instance of detecting a direction by the fingerprint ID device of the first exemplary embodiment of the present invention.

FIG. 5 shows eight directions to be detected by the fingerprint ID device in accordance with the first exemplary embodiment of the present invention.

FIG. 6 illustrates an instance of detecting a center point by the finger print ID device of the first exemplary embodiment of the present invention.

FIG. 7 illustrates an instance of extracting an area by the finger print ID device of the first exemplary embodiment of the present invention.

FIG. 8 shows a flowchart of the process done by the finger print ID device of the first exemplary embodiment of the present invention.

FIG. 9 shows a flowchart of the process done by the center detector of the finger print ID device in accordance with the first exemplary embodiment of the present invention.

FIG. 10 shows a block diagram showing functions of a center detector of a fingerprint ID device in accordance with a second exemplary embodiment of the present invention.

FIG. 11 illustrates an instance of determining a joint by the fingerprint ID device in accordance with the second exemplary embodiment of the present invention.

FIG. 12 shows a flowchart of the process done by the center detector of the finger print ID device in accordance with the second exemplary embodiment of the present invention.

FIG. 13 shows a block diagram of an area-extractor of the fingerprint ID device in accordance with a third exemplary embodiment of the present invention.

FIG. 14 illustrates an instance of detecting a fingertip by the finger print ID device in accordance with the third exemplary embodiment of the present invention.

FIG. 15 shows a flowchart of the process done by the area-extractor of the fingerprint ID device in accordance with the third exemplary embodiment of the present invention.

FIG. 16 shows a block diagram of a fingerprint ID device in accordance with a fourth exemplary embodiment of the present invention.

FIG. 17 shows a flowchart of the process done by the finger print ID device of the fourth exemplary embodiment of the present invention.

FIG. 18 is a block diagram showing functions of a center-position determining unit of a conventional fingerprint ID device.

### BEST MODE FOR CARRYING OUT THE INVENTION

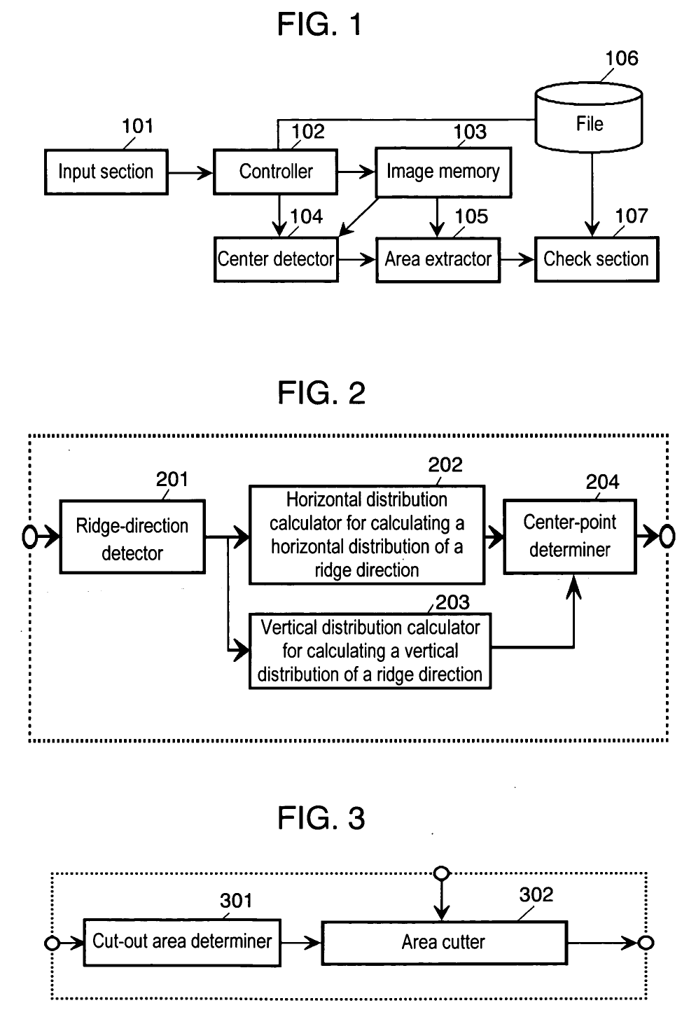

Exemplary embodiments of the present invention are demonstrated hereinafter with reference to FIG. 1 through FIG. 17.

Exemplary Embodiment 1

The fingerprint ID device in accordance with the first exemplary embodiment of the present invention carries out the following steps:

find a horizontal and a vertical distributions in a ridge direction of a fingerprint image,

determine a center-point of the fingerprint based on the horizontal and the vertical distributions;

extract a center image of the fingerprint in a given area of which center is the center-point of the fingerprint; and

check the fingerprint against fingerprint images registered.

FIG. 1 is a block diagram showing functions of the fingerprint ID device in accordance with the first embodiment. In FIG. 1, input section 101 receives a fingerprint image and converts the image into a quantized signal. The input section is embodied by hardware such as a scanner for reading an image, and an AD converter for converting a data read by the scanner into a digital data. Controller 102 controls respective blocks. Image memory 103 is controlled by controller 102 to store a fingerprint image received by input section 101. Center-detector 104 detects a fingerprint center from the fingerprint image. Area extractor 105 extracts a center image of the fingerprint from the fingerprint image, where the center image is in a given area of which center is the fingerprint center and is fed into check section 107 as a fingerprint image to be identified. File 106 stores fingerprint images, which have been registered in advance, as registered fingerprint images. Check section 107 checks the fingerprint image to be identified against the registered fingerprint images.

FIG. 2 is a block diagram showing functions of center detector 104 of the fingerprint ID device in accordance with the first exemplary embodiment of the present invention. In FIG. 2, ridge-direction detector 201 detects ridges of a fingerprint image, where a pattern of a fingerprint is formed of peaks and valleys, and the ridge means the peak portions. Horizontal distribution calculator 202 calculates the horizontal distribution of the ridge directions of the fingerprint image. Vertical distribution calculator 203 calculates the vertical distribution of the ridge directions of the fingerprint image. Center-point determiner 204 determines a center point of the fingerprint based on the horizontal and vertical distributions of the ridge directions.

FIG. 3 is a block diagram showing functions of area extractor 105 of the fingerprint ID device in accordance with the first exemplary embodiment of the present invention. In FIG. 3, cut-out area determiner 301 determines an area, having a given width and a given height, to be cut out, and area cutter 302 cuts the center image of the fingerprint from the fingerprint image according to the cut-out area.

Next, an operation of the fingerprint ID device in accordance with the first embodiment of the present invention is demonstrated hereinafter. First, the function of the device is generally described with reference to FIG. 1. Input section 101 receives a fingerprint image and converts the image into a quantized signal. The fingerprint image received by input section 101 is stored in image memory 103 by controller 102. Center detector 104 receives a data of the fingerprint image from memory 103 and detects a center point of the fingerprint. Area extractor 105 extracts a given area, of which center is the center point of the fingerprint detected by center-detector 104, from the fingerprint image stored in memory 103. Extractor 105 then sends the given area to check section 107 as a center image of the fingerprint, where this center image is a fingerprint data to be identified. File 106 stores fingerprint images, which have been registered in advance, as registered fingerprint images. Controlled by controller 102, data of a registered fingerprint image designated by an ID is read from file 106. Check section 107 checks the center image of the fingerprint extracted by area extractor 105 against the registered fingerprint image read from file 106.

Next, the function of center-detector 104 of the fingerprint ID device is described with reference to FIG. 2. Ridge-direction detector 201 detects the ridges of the fingerprint image, and finds the direction of the ridges. Data of the ridge directions detected by detector 201 is supplied to horizontal distribution calculator 202 and vertical distribution calculator 203. Calculator 202 calculates a horizontal distribution of the ridge directions of the fingerprint, and calculator 203 calculates a vertical distribution of the ridge directions. Center-point determiner 204 determines a center point of the fingerprint based on the horizontal and vertical distributions, and the data of the center point is output from the center detector.

The function of area extractor 105 of the fingerprint ID device is described with reference to FIG. 3. Cut-area determiner 301 determines an area, which has a given width and a height and includes the fingerprint center as the area center, to be a cut-area. Area cutter 302 cuts the center image of the fingerprint out of the fingerprint image according to the cut-area. Data of the center image cut out is supplied from area extractor 105.

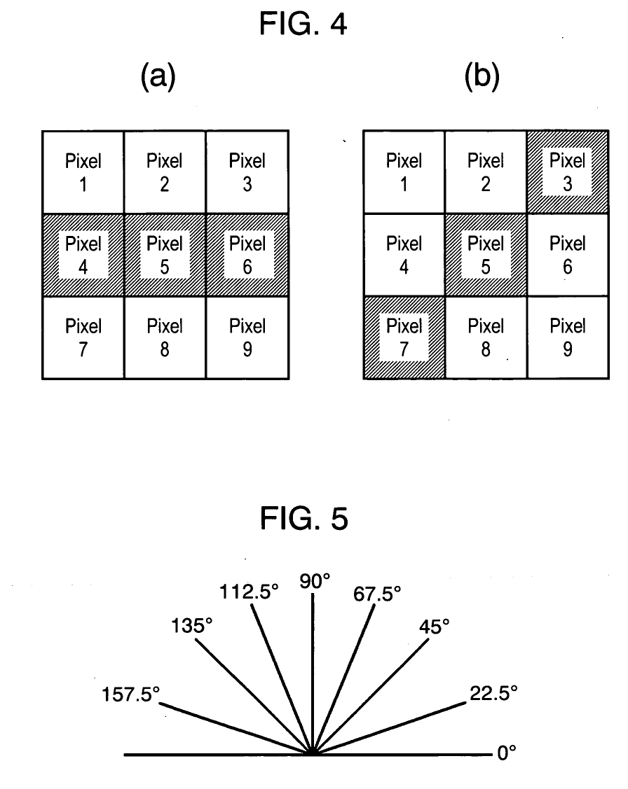

Detection of ridge-direction is described with reference to FIGS. 4 and 5. FIG. 4 shows peripheral pixels of a pixel to be focused in the fingerprint image. FIG. 5 shows eight directions of the ridges and their angles. Intensity differences between nine pixels (vertical three pixels×horizontal three pixels) are examined, so that a direction of the ridge is determined. In the case of an instance shown in FIG. 4(a), pixels 4, 5 and 6 out of the peripheral pixels have smaller intensity differences, and a signal connecting those pixels is obtained as a signal indicating a ridge direction. In this case, the ridge direction corresponds to the direction of 0 (zero) degree shown in FIG. 5, namely, the tilt is 0 degree and takes a horizontal direction. In the case of an instance shown in FIG. 4(b), pixels 3, 5 and 7 out of the peripheral pixels have smaller intensity differences, and a signal connecting those pixels is obtained as a signal indicating a ridge direction. In this case, the ridge direction corresponds to a direction of 45 degrees shown in FIG. 5.

Horizontal distribution calculator 202 shown in FIG. 2 calculates a horizontal distribution of the ridge directions which have been detected by ridge-direction detector 201. In the same manner, vertical distribution calculator 203 calculates a vertical distribution of the ridge directions which have been detected by ridge-direction detector 201.

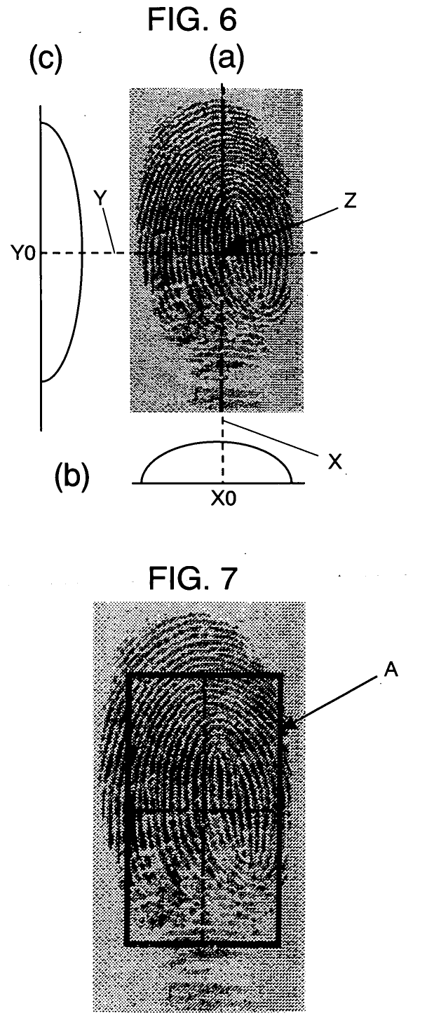

FIG. 6 shows horizontal and vertical distributions of ridges of a fingerprint. In the case of a fingerprint image shown in FIG. 6(a), a frequency distribution of the ridges in the horizontal direction is indicated by a curve shown in FIG. 6(b). FIG. 6(b) tells that a large amount of ridges in the horizontal direction are distributed at the center of the fingerprint. A frequency distribution of the ridges in the vertical direction is indicated by a curve shown in FIG. 6(c). FIG. 6(c) tells that a large amount of ridges in the vertical direction are distributed also at the center of the fingerprint.

The data about the horizontal and vertical distributions calculated by calculators 202 and 203 are supplied to center-point determiner 204, which then determines a center point of the fingerprint based on the frequency distributions shown in FIGS. 6(a) and 6(b). In FIG. 6(b), a large number of ridges in the horizontal direction are distributed at the center of the fingerprint, and position X0 corresponding to the maximum spread is determined as a horizontal center. A straight line extending through position X0 is referred to as centerline X. In the same manner, in FIG. 6(c), a large number of ridges in the vertical direction are distributed at the center of the fingerprint, and position Y0 corresponding to the maximum spread is determined as a vertical center. A straight line extending through position Y0 is referred to as centerline Y Intersection point Z of centerlines X and Y is determined as a center point of the fingerprint image. Center detector 104 outputs a data of the fingerprint center-point.

The data about the center-point of the fingerprint is supplied from center detector 104 and is fed into area extractor 105. Based on the data, area extractor 105 cuts the center image of the fingerprint out from the fingerprint image stored in memory 103. Before the cutting, area extractor 105 determines an area, which has center-point Z of the fingerprint as the area center and is surrounded by a given width and a given height, as the area to be cut out. Area extractor 105 extracts the center image of the fingerprint according to the cut-out area determined. The area surrounded by rectangular A shown in FIG. 7 corresponds to the center image extracted.

The center image extracted by area extractor 105 is output as a checking data to check section 107. On the other hand, a fingerprint image corresponding to an ID is read from the fingerprint images registered in advance in file 106, and is supplied to check section 107. Check section 107 checks the center image against the registered image.

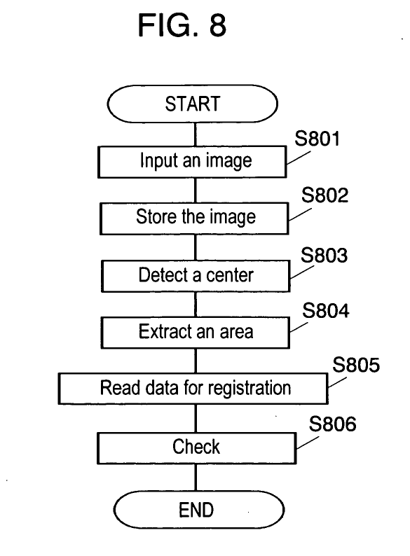

An operation procedure of the fingerprint ID device is demonstrated with reference to the flowchart shown in FIG. 8.

(1) step S801: Input section 101 receives a fingerprint image.

(2) step S802: Controller 102 prompts image memory 103 to store the fingerprint image.

(3) step S803: Center detector 104 detects a center-point of the fingerprint.

(4) step S804: Area extractor 105 extracts a given area surrounding the center-point of the fingerprint, thereby obtaining a center image of the fingerprint.

(5) step S805: Controller 102 reads a registered fingerprint image corresponding to a designated ID from file 106.

(6) step S806: Check section 107 checks the center image against the registered fingerprint image.

(7) end step : A fingerprint identification is ended.

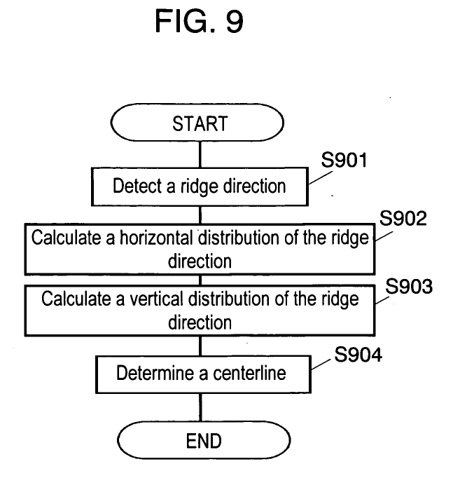

The procedure of step S803 shown in FIG. 8, i.e., center-point detection, is described more in detail with reference to the flowchart shown in FIG. 9.

(1) step S901: Center detector 104 detects a direction of ridges from the fingerprint image.

(2) step S902: Detector 104 calculates a horizontal distribution of the ridge directions.

(3) step S903: Detector 104 calculates a vertical distribution of the ridge directions.

(4) step S904: Detector 104 determines the center point of the fingerprint.

(5) end step: The procedure is ended.

As discussed above, the fingerprint ID device in accordance with the first embodiment includes the following procedures:

(1) Find horizontal and vertical distributions of ridge directions of a fingerprint image.

(2) Determine a center-point of the fingerprint.

(3) Extract a given area having the center-point of the fingerprint as the area center.

(4) Check the extracted area against a registered data.

The foregoing operations allow identifying the fingerprint by using an area including a large number of characteristics. Even if the finger deviates from a right position, the fingerprint can be identified with accuracy, and at the same time, a memory capacity can be substantially reduced. The center-point both in horizontal and vertical directions can be accurately detected, so that the center image of the fingerprint can be extracted for checking. As a result, even if the finger deviates from a right position, the fingerprint can be identified with accuracy.

Exemplary Embodiment 2

The second exemplary embodiment refers to a fingerprint ID device that checks a fingerprint against registered fingerprint-images in the following manner: Based on an intensity projection of a fingerprint image, the device detects a fingerprint area extending from the first joint to the finger tip. The device then detects a center-point of the fingerprint by using horizontal and vertical distributions of ridge directions in the fingerprint area, and extracts a given area surrounding the center-point of the fingerprint as a center image of the fingerprint. Then the device checks the center image against registered fingerprint-images.

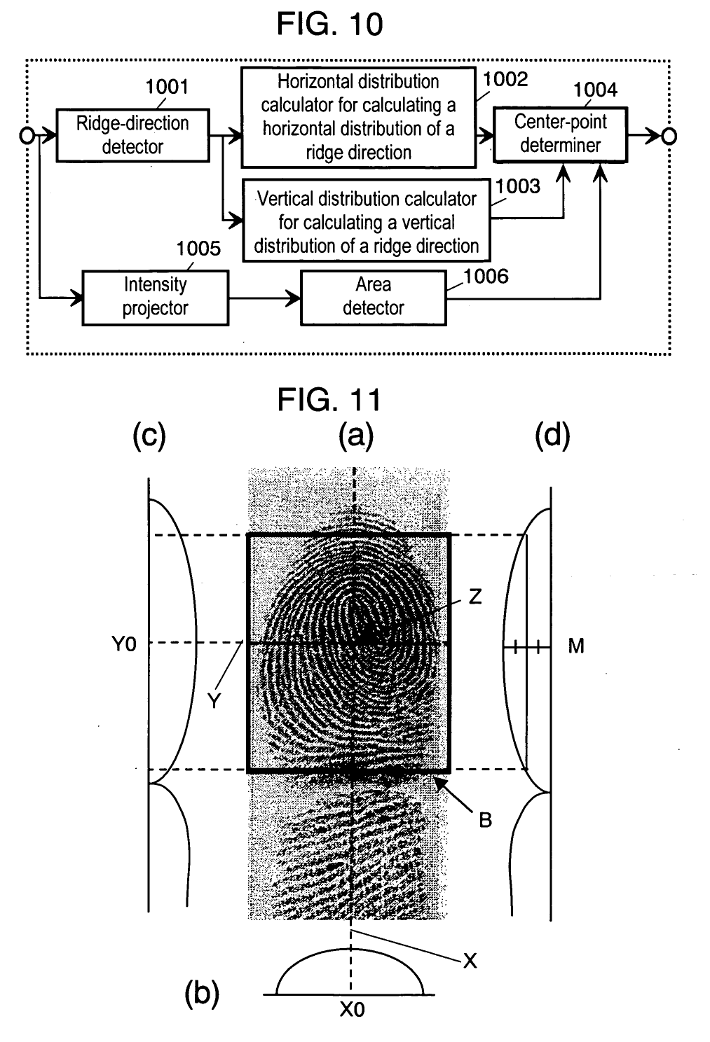

FIG. 10 shows a block diagram showing functions of a center detector of a fingerprint ID device in accordance with the second exemplary embodiment of the present invention. In FIG. 10, ridge-direction detector 1001 detects ridges of a fingerprint image. Horizontal distribution calculator 1002 calculates a horizontal distribution of the ridge directions of a fingerprint image. Vertical distribution calculator 1003 calculates a vertical distribution of the ridge directions of the fingerprint image. Center-point determiner 1004 determines a center point of the fingerprint based on the horizontal and vertical distributions of the ridge directions. Intensity projector 1005 finds intensity in the vertical direction of the fingerprint image projected. Area detector 1006 detects the fingerprint area in the fingerprint image based on the intensity of the projected image.

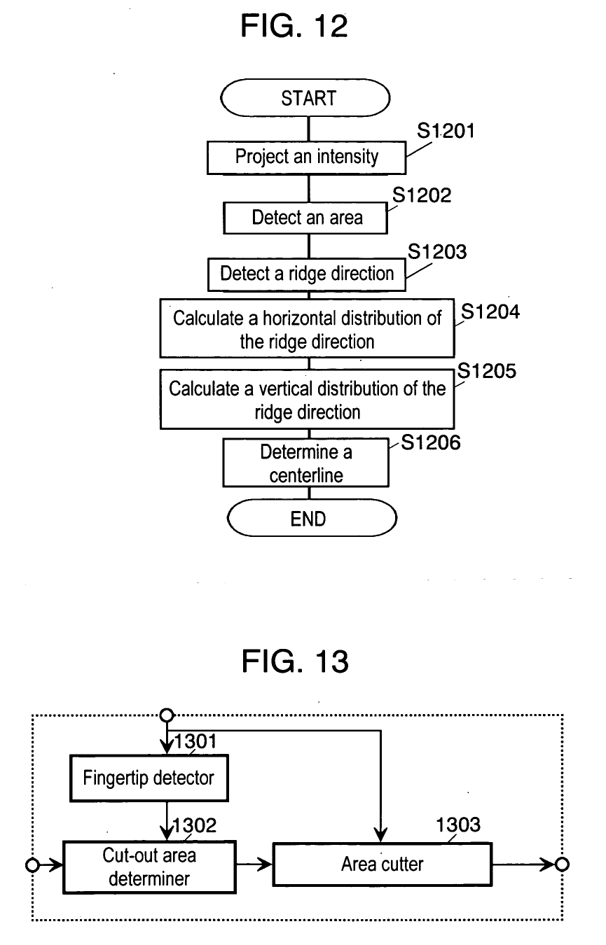

FIG. 11 illustrates a way of determining a joint by using the fingerprint ID device in accordance with the second embodiment. FIG. 12 is a flowchart illustrating a procedure carried out by a center-point detector of the fingerprint ID device. The structure of the fingerprint ID device in accordance with the second embodiment is basically the same as that of the first embodiment shown in FIG. 1.

An operation of this device is demonstrated hereinafter. In the center-point detector shown in FIG. 10, ridge-direction detector 1001 detects ridges of the fingerprint of the fingerprint image, where a pattern of the fingerprint is formed of peaks and valleys, and the ridge means the peak portions. Horizontal distribution calculator 1002 calculates a horizontal distribution of the ridge directions detected by detector 1001, and vertical distribution calculator 1003 calculates a vertical distribution of the ridge directions. The data of the horizontal and vertical distributions are supplied to center-point determiner 1004.

On the other hand, intensity projector 1005 finds intensity in the vertical direction of the fingerprint image projected. Area detector 1006 detects a fingerprint area in the fingerprint image based on the intensity found by projector 1005, and outputs the detection result to center-point determiner 1004. Determiner 1004 determines the center point of the fingerprint based on the horizontal distribution supplied from calculator 1002, the vertical distribution supplied from calculator 1003, and the fingerprint area supplied from detector 1006. Center detector 104 outputs the data of the center-point.

The procedure from when a fingerprint image is obtained and stored in an image memory to when the fingerprint image is fed into the center detector is the same as that of the first embodiment, and the description is thus omitted here. Operations of ridge-direction detector 1001 through vertical distribution calculator 1003 shown in FIG. 10 are the same as detector 201 through calculator 203 shown in FIG. 2, the descriptions of the operations are thus omitted here.

The case, where an image shown in FIG. 11(a) is supplied as a fingerprint image, is described hereinafter. Horizontal distribution calculator 1002 for calculating a horizontal distribution of ridge directions calculates the horizontal distribution of the ridge directions shown in FIG. 11(b). Vertical distribution calculator 1003 calculates the vertical distribution of the ridge directions shown in FIG. 11(c).

As shown in FIG. 10, the data of the fingerprint image is also fed into intensity projector 1005, which adds the intensity of pixels of the fingerprint image in the vertical direction, thereby finding a data of intensity projection. In the case of receiving the fingerprint image shown in FIG. 11(a), the intensity projection in the vertical direction draws the graph as shown in FIG. 11(d). FIG. 11(a) includes an image of the finger below the first joint of the finger. As the projected intensity shown in FIG. 11(d) tells, a peak of intensity is available above the first joint and below the first joint, i.e., two peaks of intensity are available in upper and lower sides of the first joint. However, a detection of the fingerprint center needs to extract a fingerprint image from the upper area than the first joint. Thus a fingerprint area is detected using this intensity distribution. First, calculate the center of gravity which corresponds to the peak of the intensity distribution. Next, define an area, which has the center of gravity as the area center and having an intensity level of a half of that of the center of gravity, as the fingerprint area. In FIG. 11(d), the center of gravity of the intensity distribution is intensity peak M, and area B of the fingerprint image surrounded by the area, of which intensity level is a half of that of the center of gravity M, is assigned as the fingerprint area.

The data of the fingerprint area is supplied to center-point determiner 1004, which then determines the center-point of the fingerprint in the fingerprint area by using frequency distributions of the ridge directions shown in FIGS. 11(b) and 11(c).

In the similar manner to the first embodiment, position X0 corresponding to the max. spread of ridge distribution in the direction of 0 (zero) degree is determined as the horizontal center. As shown in FIG. 11(b), a straight line extending through position X0 is referred to as centerline X. Position Y0 corresponding to the max. spread of ridge distribution in the direction of 90 degrees is determined as a vertical center. As shown in FIG. 11(c), a straight line extending through position Y0 is referred to as centerline Y. Intersection point Z of centerlines X and Y is determined as the center point of the fingerprint. The data of the center-point of the fingerprint detected by center-point determiner 1004 is supplied to area extractor 105 shown in FIG. 1.

Operations by area extractor 105 through check section 107 remain unchanged as those in the first embodiment, i.e., a given area, which includes the fingerprint center as the area center, is cut as a center image of the fingerprint, and checks this center image against fingerprint images registered in advance.

An operation of the second embodiment is demonstrated with reference to the flowcharts shown in FIGS. 8 and 12. The steps shown in FIG. 8 are the same as described in the first embodiment, and the descriptions thereof are thus omitted here. Step S803, shown in FIG. 8, of detecting the center-point, is formed of the following steps as described in the flowchart of FIG. 12:

(1) step S1201: Calculate an intensity projection in both horizontal and vertical directions of the fingerprint image.

(2) step S1202: Detect the fingerprint area based on the intensity projection calculated.

(3) step S1203: Detect ridge directions of the fingerprint in the fingerprint area detected.

(4) step S1204: Calculate a horizontal distribution of the ridge directions.

(5) step S1205: Calculate a vertical distribution of the ridge directions.

(6) step S1206: Determine the center point of the fingerprint based on the horizontal and vertical distributions of the ridge directions.

(7) end step: End the process.

As discussed above, the fingerprint ID device in accordance with the second embodiment includes the following procedures:

(1) Detect a fingerprint area extending from the first joint of the finger to the fingertip based on an intensity projection of the fingerprint image.

(2) Detect a center point of the fingerprint by using horizontal and vertical distributions of ridge directions in the fingerprint area.

(3) Extract a given area surrounding the center point of the fingerprint as a center image of the fingerprint, and check the center image against registered fingerprint images.

These procedures allows detecting the fingerprint area with the intensity projection, detecting a center of both in the horizontal and vertical directions with accuracy, extracting a center image, which has the center point of the fingerprint as the area center, of the fingerprint, and checking the center image against registered fingerprint images. Even if the finger deviates from the right position, the fingerprint can be checked accurately. For instance, even if an image of the finger downward from the first joint toward the base of the finger is taken at the same time, the center point of the fingerprint can be detected accurately. Therefore, even if a finger deviates from the right position, the fingerprint can be identified with accuracy.

Exemplary Embodiment 3

A fingerprint ID device in accordance with the third embodiment carries out the following steps before a center image of a fingerprint is extracted.

(1) Detect a fingertip in a fingerprint image.

(2) Set the fingertip as an upper end.

(3) Set a point vertically downward at a given distance from the center point of the fingerprint as a lower end.

(4) Determine a cut-out area having a given width on both sides of the center point of the fingerprint.

(5) Cut a center image of the fingerprint out from the fingerprint image according to the cut-out area.

FIG. 13 is a block diagram showing functions of area-extractor 105 of the fingerprint ID device in accordance with the third exemplary embodiment of the present invention. In FIG. 13, fingertip detector 1301 detects a fingertip position from a fingerprint image. Cut-out area determiner 1302 determines a cut-out area which has a given width on both sides of the center point of the fingerprint and at a lower end, and a fingertip as an upper end. Area cutter 1303 cuts the center image of the fingerprint according to the cut-out area.

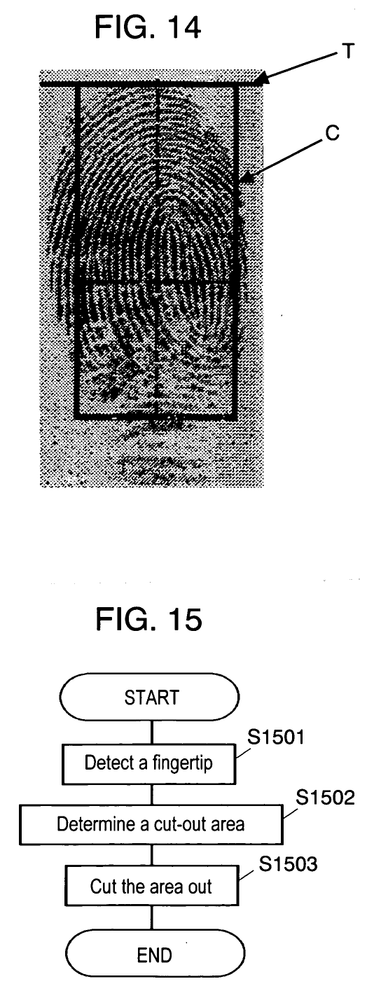

FIG. 14 illustrates how the fingerprint ID device of the third embodiment detects a fingertip. FIG. 15 is a flowchart showing a procedure carried out by the area extractor of the fingerprint ID device.

An operation of the fingerprint ID device of the third embodiment is demonstrated hereinafter. The procedures from obtaining a fingerprint image, storing the image in an image memory, detecting a center point of the fingerprint with a center detector, through supplying the data of the center point to area extractor 105 are the same as those in the first embodiment. Thus the descriptions thereof are omitted here.

Fingertip detector 1301 prepared in area extractor 105 detects a position of a fingertip in the fingerprint image. In the case of the fingerprint shown in FIG. 14, based on an average intensity level obtained from sub-areas, a fingerprint area is separated from background. In the separated fingerprint area, an upper end of the area is determined as the fingertip. In other words, the position indicated by straight line T is set as the position of the fingertip. The data, obtained as discussed above, about the fingertip is supplied to cut-out area determiner 1302, which then determines a cut-out area, having the center point of the fingerprint as the area center, based on the fingertip position detected by detector 1301 and the center point of the fingerprint. A width on both sides of the cut-out area is predetermined, and the width toward the base of the finger is also predetermined. The fingertip position is set as an upper end of the cut-out area. The area surrounded by rectangular C shown in FIG. 14 is determined the cut-out area. Based on this cut-out area determined by determiner 1302, area cutter 1303 cuts the center image of the fingerprint from the entire fingerprint image. The center image cut by cutter 1303 is output from area extractor 105.

Operations by area extractor 105 through check section 107 remain unchanged as those in the first embodiment, i.e., a given area including the fingerprint center as the area center is cut as a center image of the fingerprint from the fingerprint image, and this center image is checked against fingerprint images registered in advance.

An operation of the fingerprint ID device of the third embodiment is demonstrated with reference to the flowcharts shown in FIGS. 8 and 15. The steps shown in FIG. 8 except the step of extracting an area are the same as described in the first embodiment, and the descriptions thereof are thus omitted here. Step S804, shown in FIG. 8, of extracting an area, is formed of the following steps as described in the flowchart of FIG. 15:

(1) step S1501: Detect a fingertip position from a fingerprint image.

(2) step S1502: Determine a cut-out area having an upper end at the fingertip position and having a given width at the other directions.

(3) step S1503: Cut a center image of the fingerprint out from the fingerprint image according to the cut-out area determined.

(4) end step: End the operation.

The foregoing fingerprint ID device in accordance with the third embodiment includes the following procedures:

(1) Detect a position of a fingertip from a fingerprint image before a center image of the fingerprint image is extracted.

(2) Determine a cut-out area having an upper end at the fingertip position, a lower end at a point vertically downward at a given distance from the center point of the fingerprint, and a given width on both sides of the center point.

(3) Cut a center image of the fingerprint out from the fingerprint image according to the cut-out area.

The procedures discussed above allows cutting the cut-out area having the center point of the fingerprint as the area center and extending to the fingertip, and checking the fingerprint by using the center image that includes a large number of characteristics of the fingerprint, so that an accurate check of the fingerprint can be expected. The fingerprint can be thus checked using an area which includes a larger number of characteristics than an area having a given width. As a result, more accurate check can be expected.

Exemplary Embodiment 4

A fingerprint ID device in accordance with the fourth embodiment displays a message requesting an input of the fingerprint again when a center point of the fingerprint cannot be detected from the fingerprint image. The device then extracts a center image of the fingerprint of a given area having a center point of the fingerprint as the area center, and checks the center image against fingerprint images registered in advance.

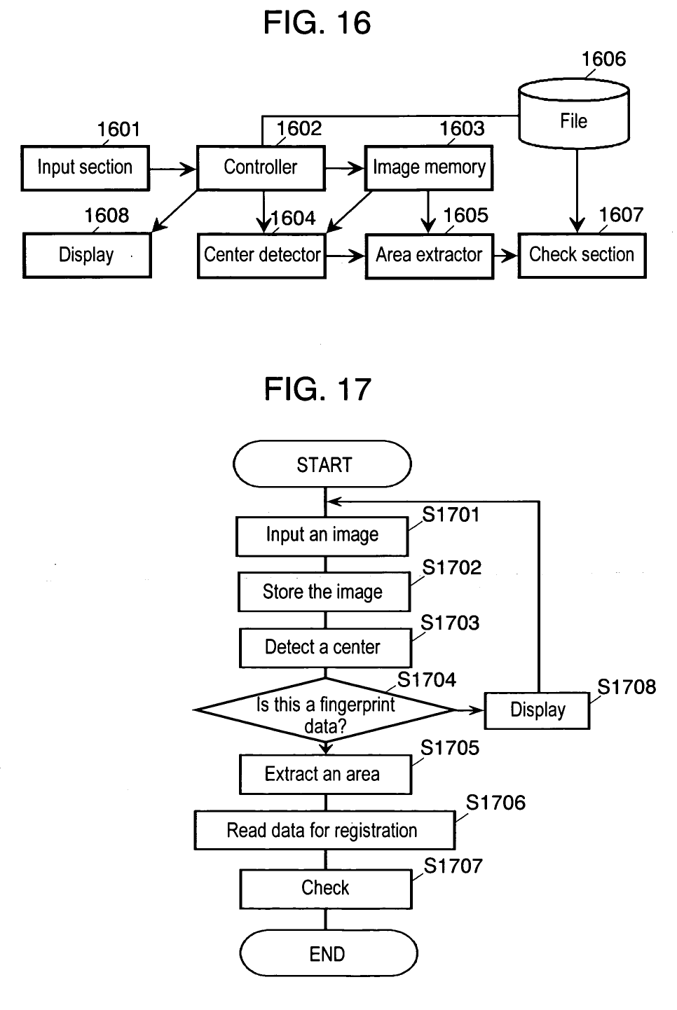

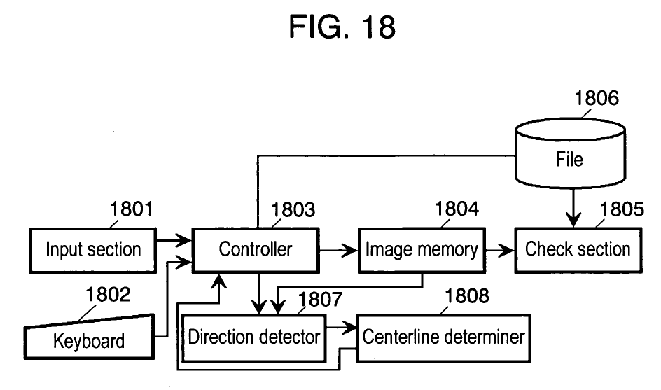

FIG. 16 is a block diagram showing functions of the fingerprint ID device in accordance with the fourth exemplary embodiment of the present invention. In FIG. 16, display 1608 requests a user to input the fingerprint again. Display 1608 can be formed of, e.g., a micro-processor for controlling data to be displayed, a video RAM for storing image data, and a screen for actually showing an image. An LCD or a CRT can be used as a screen.

The processes from input section 1601 through check section 1607 are similar to those of input section 101 through check section 107 shown in FIG. 1. FIG. 17 is a flowchart showing processes of the fingerprint ID device in accordance with the fourth embodiment.

An operation of the fingerprint ID device in accordance with the fourth embodiment is demonstrated hereinafter. In the fingerprint ID device shown in FIG. 16, the procedures, from obtaining a fingerprint image, detecting a center point of the fingerprint, extracting a center image of the fingerprint of an area having the center point as the area center, through checking the center image against fingerprint images registered in advance, are the same as those in the first embodiment.

Center detector 1604 determines, based on horizontal and vertical distributions of ridge directions of a fingerprint, whether or not an image is a fingerprint image. When center detector 1604 detects a center point of a fingerprint from a fingerprint image, the distributions of ridge directions shown in FIGS. 6(b) and 6(c) are obtained if the image is a fingerprint image, so that the center point can be detected. If the image is not a fingerprint image, the distributions shown in FIGS. 6(b) and 6(c) cannot be obtained, so that the center point cannot be detected. In such a case, center detector 1604 determines that the image is not a fingerprint image, and give a notice to controller 1602, which then issues a warning to a user that the input image is not a fingerprint image. For instance, a warning message of “Re-enter a fingerprint.” is displayed on display 1608, or LEDs mounted to the device in advance blink for warning. When an image data received by input section 1601 is a fingerprint image, a center point of the fingerprint is detected. Then area extractor 1605 extracts a center image of the fingerprint, and checks the center image against fingerprint images registered in advance.

An operation of the fourth embodiment is demonstrated with reference to the flowchart shown in FIG. 17.

(1) step S1701: Receive a fingerprint image.

(2) step S1702: Store the fingerprint image in an image memory.

(3) step S1703: Detect a center point of the fingerprint.

(4) step S1704: Depending on a detection of the center point, determine whether or not the image received is a fingerprint image. When the image is determined as a fingerprint image, move on to step S1705. When the image is determined as not a fingerprint image, move on to step S1708.

(5) step S1705: Extract a center image of the fingerprint.

(6) step S1706: Read a registered fingerprint image corresponding to a designated ID from a file.

(7) step S1707: Check the center image against the registered fingerprint image in a check section.

(8) end step: End the operation.

(9) Display a message to prompt a user to re-enter a fingerprint in step S1708.

(10) Return to step S1701.

The fingerprint ID device in accordance with the fourth embodiment carries out the following procedures:

(1) Display a message to prompt a user to re-enter another fingerprint if a center point of a fingerprint cannot detected from a fingerprint image.

(2) Extract a center image of the fingerprint image in a given area including the center point of the fingerprint as the area center.

(3) Check the center image against fingerprint images registered in advance.

These procedures advantageously allows inputting only a fingerprint image, detecting a center point of a fingerprint, cutting a center image of the fingerprint out from the fingerprint image, and checking accurately the center image against registered fingerprint images. If a fingerprint image cannot be received, and a center point of a fingerprint cannot be detected, the message of this fact is displayed for issuing a warning to a user. As a result, a fingerprint ID device with improved ease-of-use can be provided.

### Industrial Applicability

The fingerprint ID device of the present invention extracts an area including a large number of characteristics, thereby checking data of a fingerprint. Even if a finger deviates from a right position, the fingerprint can be accurately identified. This fingerprint ID device can substantially reduce its memory capacity.

1. A fingerprint ID device comprising:
input means for receiving a fingerprint image;
center detecting means for detecting a center point of a fingerprint from the fingerprint image;
area extracting means for extracting a given area, which surrounds the center point, as a center image of the fingerprint; and
checking means for checking the center image against fingerprint images registered in advance.

2. The fingerprint ID device of claim 1, wherein said center detecting means including:
ridge-direction detecting means for detecting a ridge direction of the fingerprint image;
horizontal distribution calculating means for calculating a horizontal distribution of the ridge direction;
vertical distribution calculating means for calculating a vertical distribution of the ridge direction; and
center-point determining means for determining a center point of the fingerprint based on the horizontal distribution and the vertical distribution of the ridge direction.

3. The fingerprint ID device of claim 1, wherein said center detecting means including:
ridge-direction detecting means for detecting a ridge direction of the fingerprint image;
intensity projection calculating means for calculating an intensity projection of the fingerprint image;
area detecting means for detecting a fingerprint area based on the intensity projection;
horizontal distribution calculating means for calculating a horizontal distribution of the ridge direction within the fingerprint area;
vertical distribution calculating means for calculating a vertical distribution of the ridge direction within the fingerprint area; and
center-point determining means for determining a center point of the fingerprint based on the horizontal distribution and the vertical distribution of the ridge direction.

4. The fingerprint ID device of claim 1, wherein said area extracting means including:
cut-out area determining means for determining a cut-out area surrounding the center point of the fingerprint and having a given width and a given height; and
area cutting means for cutting the center image of the fingerprint out from the fingerprint image according to the cut-out area.

5. The fingerprint ID device of claim 1, wherein said area extracting means including:
fingertip detecting means for detecting a position of a fingertip from the fingerprint image;
cut-out area determining means for determining a cut-out area which has the position of the fingertip as an upper end, a position vertically downward at a given distance from the center point of the fingerprint, and a given width on both sides of the center point of the fingerprint; and
area cutting means for cutting the center image of the fingerprint out from the fingerprint image according to the cut-out area.

6. The fingerprint ID device of claim 1 further comprising:
display means for displaying a sign which prompts to re-enter a fingerprint when said center detecting means cannot detect the center point of the fingerprint.

7. A method of identifying a fingerprint, the method comprising the steps of:
receiving a fingerprint image;
detecting a center point of a fingerprint from the fingerprint image;
extracting a given area, which surrounds the center point, as a center image of the fingerprint; and
checking the center image against fingerprint images registered in advance.

8. The method of identifying a fingerprint of claim 7, wherein the step of detecting includes the steps of:
detecting a ridge direction of the fingerprint image;
calculating a horizontal distribution and a vertical distribution of the ridge direction; and
determining a center point of the fingerprint based on the horizontal distribution and the vertical distribution of the ridge direction.

9. The method of identifying a fingerprint of claim 7, wherein the step of detecting includes the steps of:
calculating a intensity projected from the fingerprint image;
detecting a fingerprint area based on the projected intensity;
detecting a ridge direction of the fingerprint image;
calculating a horizontal distribution and a vertical distribution of the ridge direction within the fingerprint area; and
determining a center point of the fingerprint based on the horizontal distribution and the vertical distribution of the ridge direction.

10. The method of identifying a fingerprint of claim 7, wherein the step of extracting carries out cutting an image, which has a given width and a given height with reference to the center point of the fingerprint, out from the fingerprint image as the center image of the fingerprint.

11. The method of identifying a fingerprint of claim 7, wherein the step of extracting includes the steps of:
detecting a position of a fingertip from the fingerprint image;
determining a cut-out area which has the position of the fingertip as an upper end, a position vertically downward at a given distance from the center point of the fingerprint, and a given width on both sides of the center point of the fingerprint; and
cutting the center image of the fingerprint out from the fingerprint image according to the cut-out area.

12. The method of identifying a fingerprint of claim 7 further comprising the step of:
displaying a sign which prompts to re-enter a fingerprint when the center point of the fingerprint cannot be detected.

13. A program executed by a computer, the program including the steps of:
receiving a fingerprint image;
detecting a center point of a fingerprint from the fingerprint image;
extracting a given area, which surrounds the center point, as a center image of the fingerprint; and
checking the center image against fingerprint images registered in advance.

14. The program of claim 13, wherein the step of detecting includes the steps of:
detecting a ridge direction of the fingerprint image;
calculating a horizontal distribution and a vertical distribution of the ridge direction; and
determining a center point of the fingerprint based on the horizontal distribution and the vertical distribution of the ridge direction.

15. The program of claim 13, wherein the step of detecting includes the steps of:
detecting a ridge direction of the fingerprint image;
calculating an intensity projection from the fingerprint image;
detecting a fingerprint area based on the intensity projection;
calculating a horizontal distribution and a vertical distribution of the ridge direction within the fingerprint area; and
determining a center point of the fingerprint based on the horizontal distribution and the vertical distribution of the ridge direction.

16. The program of claim 13, wherein the step of extracting carries out cutting an image, which has a given width and a given height with reference to the center point of the fingerprint, out from the fingerprint image as the center image of the fingerprint.

17. The program of claim 13, wherein the step of extracting includes the steps of:
detecting a position of a fingertip from the fingerprint image;
determining a cut-out area which has the position of the fingertip as an upper end, a position vertically downward at a given distance from the center point of the fingerprint, and a given width on both sides of the center point of the fingerprint; and
cutting the center image of the fingerprint out from the fingerprint image according to the cut-out area.

18. The program of claim 13 further including the step of displaying a sign which prompts to re-enter a fingerprint when the center point of the fingerprint cannot be detected.
